(19) United States
(12) Patent Application Publication
(10) Pub. No.: US 2013/0186080 A1
(43) Pub. Date: Jul. 25, 2013

(54) ACTUATOR

(71) Applicant: MITSUBISHI HEAVY INDUSTRIES, LTD., Tokyo (JP)

(72) Inventors: Masaki HATA, Tokyo (JP); Toshinari NISHIMURA, Tokyo (JP); Kazuhito KAWAMURA, Tokyo (JP)

(73) Assignee: MITSUBISHI HEAVY INDUSTRIES, LTD., Tokyo (JP)

(21) Appl. No.: 13/726,881

(22) Filed: Dec. 26, 2012

(30) Foreign Application Priority Data
Jan. 25, 2012 (JP) 2012-013218

(51) Int. Cl. F15B 15/22; F15B 15/08

(52) U.S. Cl. CPC F15B 15/226; F15B 15/088
USPC 60/371; 251/63.6

(57) ABSTRACT

An actuator related to the present invention includes a cylinder that has a tubular shape and is filled with a fluid; a piston that divides the inside of the cylinder into a first chamber and a second chamber in an axial direction of the cylinder, is reciprocable inside the cylinder, and opens and closes a main valve; a fluid supplying device for supplying the fluid to the second chamber; biasing device for biasing the piston in the axial direction toward the second chamber; a flow passage that communicates between the first chamber and the second chamber; and a pilot valve that cuts off the flow passage communicating between the first chamber and the second chamber.

### TECHNICAL FIELD

The present invention relates to an actuator that opens and closes a main valve. Priority is claimed on Japanese Patent Application No. 2012-013218, filed Jan. 25, 2012, the content of which is incorporated herein by reference.

### BACKGROUND ART

For example, steam turbines are provided with a steam valve (main valve) for controlling the flow of steam (fluid). The steam valve is connected to a piston of an actuator, and is opened and closed by the reciprocal movement of the piston within the cylinder. This type of steam valve requires quick closing (or quick opening).

In recent years, with an increase in the flow rate of steam, the throat diameter of the steam valve has been enlarged, for example, from 27.5 inches to 30 inches, and the diameter of the cylinder of the actuator that actuates this steam valve has been enlarged, for example, from 8 inches to 9 inches. However, on the other hand, as for the closing time (or time to opening) of the valve, a closing time (or time to opening) of the valve equal to that of a conventional one is required, and it is thus necessary to more rapidly discharge or supply a fluid (hydraulic oil or the like) within the cylinder.

As such an actuator for opening and closing the valve, an actuator provided with a cylinder, a piston, and a main valve (turbine bypass valve), as shown in the following Patent Document 1, is known. The cylinder has a tubular shape, and is filled with a fluid (pressure oil). The piston divides the inside of the cylinder into a first chamber (piston lower chamber) and a second chamber (piston upper chamber) in an axial direction of the cylinder, and is reciprocable inside the cylinder. The main valve is opened and closed by the movement of the piston. In addition, quick opening is aimed at in the actuator of Patent Document 1.

In the actuator of this Patent Document 1, pilot valves are connected to the first chamber and the second chamber, respectively. The piston can be rapidly moved by discharging the fluid of the second chamber through one pilot valve (quick pressure oil discharge valve) of these pilot valves, and simultaneously supplying the fluid to the first chamber through the other pilot valve (quick pressure oil supply valve).

### PRIOR ART DOCUMENT

### Patent Document

[Patent Document 1] Japanese Unexamined Patent Application, First Publication No. S56-2406

### DISCLOSURE OF THE INVENTION

### Problem that the Invention is to Solve

However, in the aforementioned actuator of the related art, one pilot valve for the second chamber (for fluid discharge) and the other pilot valve for the first chamber (for fluid supply) need to be used, and the structure of the actuator of the related art becomes complicated. Additionally, if the discharge amount and the supply amount of the fluid passing through these pilot valves are not balanced, the piston cannot be rapidly moved, and there could be a problem in controllability (stability of the opening and closing operation of the main valve).

Moreover, in this type of actuator, as mentioned above, the diameter of the cylinder is enlarged, while the opening-and-closing time of the main valve is required to be less than or equal to that of the related art.

The actuator related to the present invention provides an actuator that can open and close a main valve quickly and stably while making structure of the actuator simple.

### Means for Solving the Problems

In order to solve the above object, the present invention suggests the following means.

That is, an actuator related to the present invention includes a cylinder that has a tubular shape and is filled with a fluid; a piston that divides the inside of the cylinder into a first chamber and a second chamber in an axial direction of the cylinder, is reciprocable inside the cylinder, and opens and closes a main valve; a fluid supplying device for supplying the fluid to the second chamber; a biasing device for biasing the piston (applying an additional force to the piston) in the axial direction toward the second chamber; a flow passage that communicates between the first chamber and the second chamber; and a pilot valve that cuts off the flow passage communicating between the first chamber and the second chamber.

In the actuator related to the present invention, the inside of the cylinder filled with a fluid is divided into the first chamber and the second chamber by the piston. The piston is biased toward the second chamber by the biasing device. The fluid is supplied to the second chamber from the fluid supply device so as to resist the biasing force applied by the biasing device. That is, the internal pressure of the second chamber is made higher than the internal pressure of the first chamber, and the biasing force that biases the piston toward the second chamber and the internal pressure of the second chamber are balanced. And thus, the piston is arranged at a predetermined position within the cylinder. That is, the force directed to the second chamber is applied to the piston by the internal pressure of the first chamber and the biasing device, and the force directed to the first chamber is simultaneously applied to the piston by the internal pressure of the second chamber. The piston is arranged within the cylinder at a position where the force directed to the second chamber and the force directed to the first chamber are balanced.

From this state, the pilot valve opens the flow passage, which is cut off by the pilot valve, to allow the first chamber and the second chamber to communicate with each other, the internal pressures of the first chamber and the second chamber become equal to each other, and the piston is moved to the second chamber by the biasing force applied by the biasing device. Thereby, the main valve is quickly closed (or opened if biasing force applied by the biasing device is directed to the first chamber).

According to the actuator of the present invention, only one pilot valve has to be provided in the flow passage that allows the first chamber and the second chamber to communicate with each other, and the structure of the actuator is simple. Additionally, since the amount (discharge amount) of the fluid discharged from the second chamber and the amount (supply amount) of the fluid supplied to the first chamber can be easily made equal to each other, the effects are exhibited that the movement of the piston can be rapidly and stably performed, and the main valve connected to the piston can be rapidly and stably opened and closed (hereinafter, “the aforementioned effects” indicate the above description).

Additionally, in the actuator related to the present invention, an inner wall of the flow passage may be formed with a guide portion that gradually changes the flowing direction of the fluid stepwise or continuously.

In this case, when the pilot valve is opened, the flowing direction of the fluid that is directed from the second chamber to the first chamber is smoothly changed stepwise or continuously by the guide portions within the flow passage, and the fluid is not easily separated (spaced apart) from the inner wall of the flow passage. That is, the hydraulic oil flows along the inner wall, and the pressure loss is reduced. Accordingly, the flow velocity of the fluid that flows through the flow passage can be raised, and the aforementioned effects become more remarkable.

In addition, in forming such a guide portion, for example, chamfering processing and curved surface (R) processing can be used.

Additionally, in the actuator of the present invention, the pilot valve may include a valve body that abuts an opening edge of a hole portion that forms a portion of the flow passage, thereby blocking the opened hole portion, and the guide portion may be formed at least at the opening edge of the hole portion.

In this case, the valve body of the pilot valve abuts the opening edge of the hole portion in the flow passage, and blocks the opened hole portion, and thereby, the communicating flow passage is cut off. Also, since the guide portion is formed at least at the opening edge of the hole portion, when the valve body is spaced apart from the opening edge of the hole portion to open the hole portion, the pressure loss of the fluid that flows between the opening edge and the valve body is effectively suppressed, and the aforementioned effects are markedly obtained.

Additionally, in the actuator of the present invention, the guide portion may be formed by chamfering processing of C0.4 to 0.6.

In addition, the notation using the symbol C is a notation based on JIS (Japanese Industrial Standards). The symbol C of the notation is the initial letter of Chamfer and a numerical value of the notation is a dimensional value in units of mm when chamfering is performed at 45 degrees. When the chamfering is performed at 45 degrees, a corner is cut off into an isosceles right triangle. The above numerical value is the length of one side of two equal-length sides of the cut off corner.

In this case, the aforementioned effects are more markedly obtained. That is, in a case where the guide portion is formed by chamfering smaller than chamfering of C0.4, there is a concern that the aforementioned effect of suppressing pressure loss may not be sufficiently obtained. Additionally, when the guide portion is formed by chamfering larger than chamfering of C0.6, there is a concern that securement of the sealing performance of the seat of the valve body with respect to the opening edge of the hole portion may become difficult. Accordingly, it is preferable that the chamfering processing of the guide portion be C0.4 to 0.6.

Additionally, in the actuator of the present invention, the pilot valve may include a valve body that abuts an opening edge of a hole portion that forms a portion of the flow passage, thereby blocking the opened hole portion, and the diameter of the valve body may be 3.0 to 5.0 inches.

In this case, since the diameter of the valve body is 3.0 to 5.0 inches, and a large internal diameter of the hole portion blocked by the valve body can be secured, the flow rate of the fluid per unit time that has passed through the hole portion can be increased. Accordingly, the main valve can be more quickly opened and closed.

That is, if the diameter of the valve body is made smaller than 3.0 inches, there is a concern that the flow rate of the fluid cannot be increased, and if the diameter of the valve body is made larger than 5.0 inches, it is not preferable because the outer shape of the pilot valve also becomes larger correspondingly and interference is likely to occur in various piping or the like in plants. Accordingly, it is preferable that the diameter of the valve body be 3.0 to 5.0 inches.

Additionally, in the actuator of the present invention, the fluid may be supplied to a pressure receiving chamber of the pilot valve so that a pressure of the pressure receiving chamber becomes equal to that of the second chamber, the pilot valve may include a valve body that abuts an opening edge of a hole portion that forms a portion of the flow passage, thereby blocking the opened hole portion, and a pressure receiving body that is connected to the valve body, is disposed inside the pressure receiving chamber, and presses the valve body toward the hole portion by the pressure of the fluid supplied to the pressure receiving chamber, and the ratio of the area by which the valve body receives pressure from the fluid of the hole portion to the area by which the pressure receiving body receives pressure from the fluid of the pressure receiving chamber may be 0.7 to 0.8.

In this pilot valve, when (a pressure receiving area A2)×(the internal pressure of the hole portion) exceeds (a pressure receiving area A1)×(the internal pressure of the pressure receiving chamber), the pilot valve is opened. It is noted herein that the pressure receiving area A1 is the area by which the pressure receiving body receives pressure from the fluid of the pressure receiving chamber, and the pressure receiving area A2 is the area by which the valve body receives pressure from the fluid of the hole portion. According to the present invention, since (the pressure receiving area A2)/(the pressure receiving area A1) is raised to 0.7 to 0.8, the pilot valve can be more quickly operated.

In addition, if (the pressure receiving area A2)/(the pressure receiving area A1) becomes smaller than 0.7, there is a concern that the effect of quick operation of the pilot valve may not be sufficiently obtained. Additionally, if (the pressure receiving area A2)/(the pressure receiving area A1) becomes larger than 0.8, there is a concern that securement of the sealing performance of the seat of the valve body with respect to the opening edge of the hole portion may become difficult. Accordingly, it is preferable that (the pressure receiving area A2)/(the pressure receiving area A1) be 0.7 to 0.8.

### Advantageous Effects of Invention

According to the actuator of the present invention, the main valve can be quickly and stably opened and closed while making the structure of the actuator simple.

### BRIEF DESCRIPTION OF THE DRAWINGS

FIG. 1 is a view illustrating an actuator and a fluid path related to one embodiment of the present invention.

FIG. 2 is a view illustrating the actuator and the fluid path related to one embodiment of the present invention.

FIG. 3 is a view showing the actuator related to one embodiment of the present invention.

FIG. 4 is an enlarged view showing main part of the actuator related to one embodiment of the present invention.

FIG. 5 is a view illustrating a time chart when a valve of the actuator related to one embodiment of the present invention is closed.

### BEST MODE FOR CARRYING OUT THE INVENTION

An actuator related to one embodiment of the present invention is used for, for example, a steam turbine to open and close a steam valve (main valve) that cuts off or communicates the flow of steam (fluid).

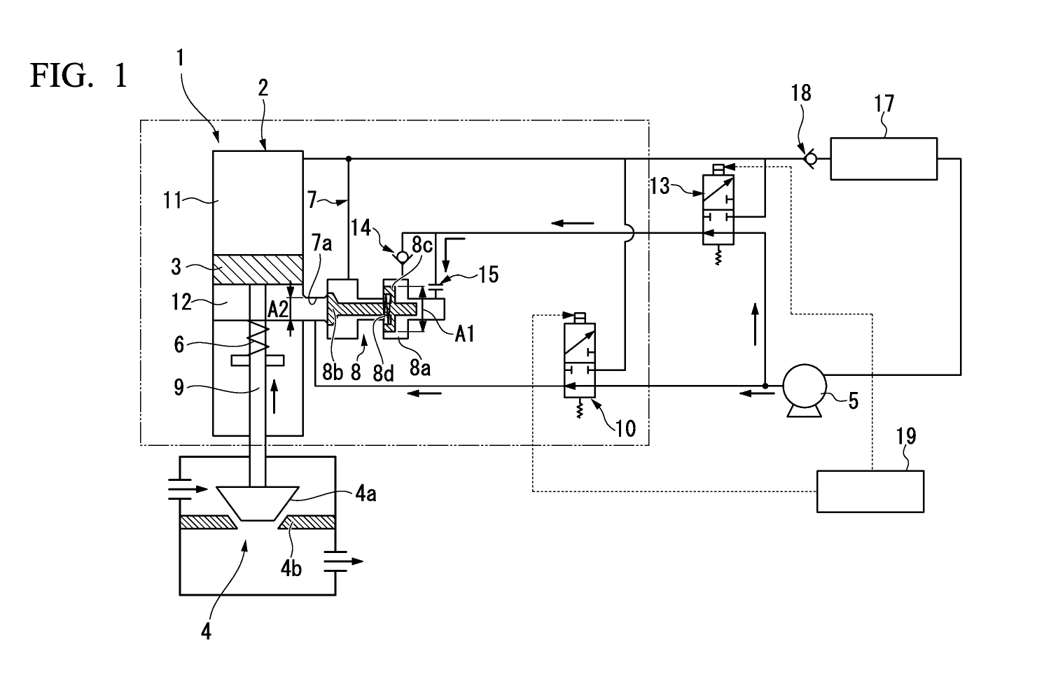

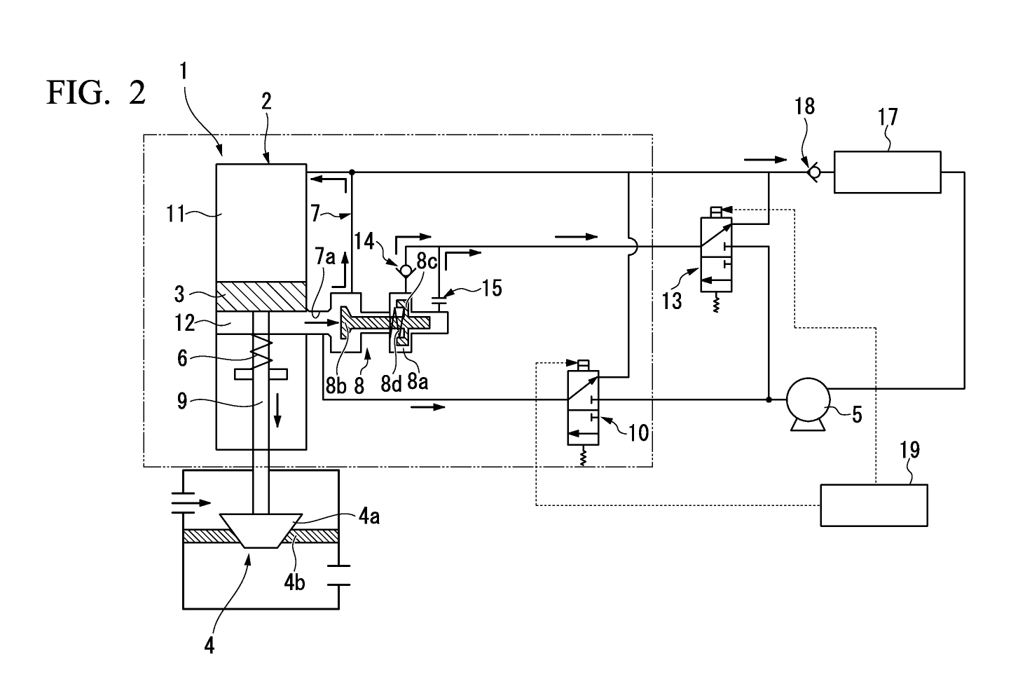

As shown in FIGS. 1 and 2, an actuator 1 of the present embodiment is provided with a cylinder 2, a piston 3, a fluid supplying device, an elastic member (biasing device) 6, a flow passage 7, and a dump valve (pilot valve) 8. The cylinder 2 has a tubular shape, and is filled with hydraulic oil (fluid). The piston 3 divides the inside of the cylinder 2 into a first chamber 11 and a second chamber 12 in an axial direction (vertical direction in FIGS. 1 and 2) of the cylinder 2, is reciprocable inside the cylinder, and opens and closes a steam valve (main valve) 4. The fluid supplying device supplies hydraulic oil to the second chamber 12. The elastic member (biasing device) 6 biases the piston 3 in the axial direction toward the second chamber 12. The flow passage 7 allows the first chamber 11 and the second chamber 12 to communicate with each other. The dump valve (pilot valve) 8 opens or blocks the flow passage 7.

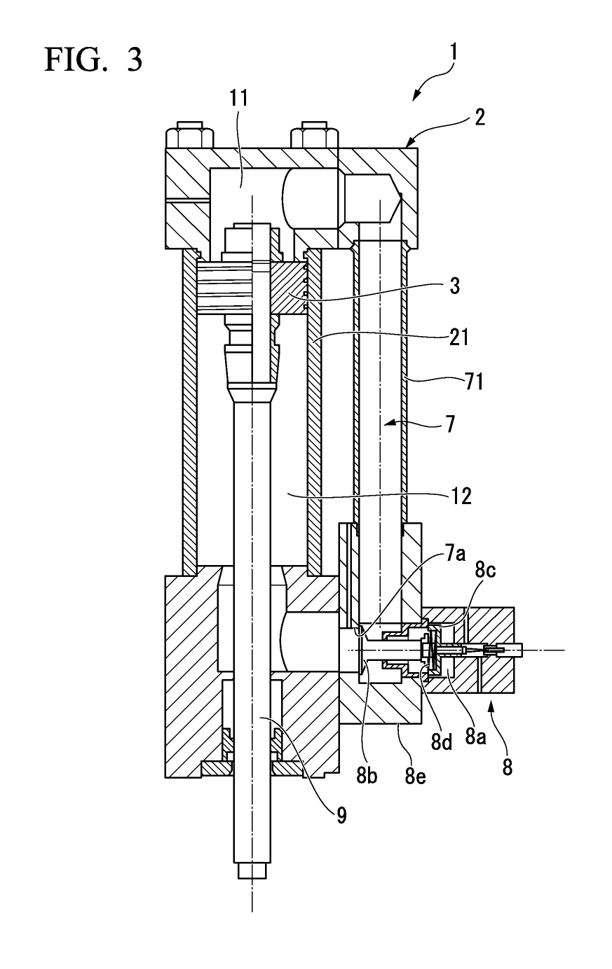

In the actuator 1 of the present embodiment, as shown in FIG. 3, the dump valve 8 is integrally incorporated into the cylinder 2. Specifically, the first chamber 11 of the cylinder 2 is connected with the dump valve 8 through the flow passage 7 inside of a piping member 71 that is adjacent in parallel to the cylinder 2. On the other hand, the piping member is not provided between the second chamber 12 of the cylinder 2 and the dump valve 8, and the second chamber 12 of the cylinder 2 is directly connected with the dump valve 8 through a hole portion 7a that is a fluid port formed in a casing 8e of the dump valve 8. By virtue of such a configuration, the actuator 1 of the present embodiment can reduce the number of parts. Additionally, since the actuator 1 itself can be made small, the actuator can be installed even in a narrow space. Moreover, since the second chamber 12 of the cylinder 2 is directly connected with the dump valve 8 through the fluid port (hole portion 7a), the length of the fluid port can be shortened.

By shortening the length of the fluid port, the response of the steam valve 4 improves because a large amount of hydraulic oil for control can be rapidly made to flow from the second chamber 12 of the cylinder 2 to a tank through the fluid port. Additionally, the pressure loss of the hydraulic oil for control that passes through the fluid port decreases.

Here, fluid supplying device is a servo switching valve 10 connected to the pump 5, and members within a region surrounded by two-dot chain lines in FIGS. 1 and 2 are constituent elements of the actuator 1 of the present embodiment. Additionally, the actuator 1 of the present embodiment is connected to one of each of the pump 5, a solenoid valve 13, a tank 17, a check valve 18, and a control unit 19, and a plurality of the actuators are disposed in parallel with each other.

The steam valve 4 is provided with a valve portion 4a and a valve seat 4b, and the valve portion 4a is connected to the piston 3 via a rod 9 that extends along the axial direction of the cylinder 2. In a state shown in FIG. 1, the flow of steam in the steam valve 4 is allowed by spacing the valve portion 4a apart from the valve seat 4b. Additionally, in a state shown in FIG. 2, the flow of the steam in the steam valve 4 is cut off as the valve portion 4a abuts (fits to) the valve seat 4b.

The steam valve 4 of the present embodiment cuts off the flow of steam by being quickly closed from the state (communication state) where the flow of steam is allowed.

The throat diameter of the steam valve 4 in the present embodiment is, for example, 30 inches, and the diameter of the cylinder of the actuator 1 that drives (operates to open and close) the steam valve 4 is, for example, 9 inches.

The hole portion 7a is located between the second chamber 12 and the dump valve 8 in the flow passage 7 formed outside the cylinder 2, and the pump 5 is connected to the hole portion 7a via the servo switching valve 10, and is enabled to supply hydraulic oil to the second chamber 12.

Additionally, the pump 5 is connected to a pressure receiving chamber 8a of the dump valve 8 via the solenoid valve 13. A piping line for hydraulic oil that connects the pressure receiving chamber 8a and the solenoid valve 13 is branched at a portion on the pressure receiving chamber 8a side, and these branch lines communicate with the pressure receiving chamber 8a. Additionally, one of these branch lines is provided with a check valve 14, and the other branch line is provided with a porous orifice 15. In the one branch line, the check valve 14 cuts off flow of the hydraulic oil that is directed from the solenoid valve 13 to the pressure receiving chamber 8a, while allowing flow of the hydraulic oil that is directed from the pressure receiving chamber 8a to the solenoid valve 13.

The pump 5 supplies hydraulic oil to the pressure receiving chamber 8a of the dump valve 8 so that a pressure (internal pressure) of the pressure receiving chamber 8a becomes equal to that of the second chamber 12.

In addition, in the following description, the hydraulic oil supplied from the pump 5 to the second chamber 12 is referred to as high-pressure oil, and the hydraulic oil supplied from the pump 5 to the pressure receiving chamber 8a of the dump valve 8 is referred to as emergency cutoff oil.

In the state shown in FIG. 1, the servo switching valve 10 communicates a flow passage between the pump 5 and the second chamber 12 through the hole portion 7a of the flow passage 7. On the other hand, in the state shown in FIG. 2, a port of the servo switching valve 10 is switched from the state of FIG. 1. The servo switching valve 10 cuts off the flow passage between the second chamber 12 and the pump 5, and communicates a flow passage between the second chamber 12 and the tank 17 through the hole portion 7a of the flow passage 7. The tank 17 is opened to the atmosphere. In addition, reference numeral 18 in the drawings represents a check valve that is arranged on the upstream side of the tank 17 to prevent hydraulic oil from flowing back from the tank 17 toward the upstream side thereof. Additionally, the pump 5 is connected to the downstream side of the tank 17.

Additionally, in the state shown in FIG. 1, the solenoid valve 13 communicates a flow passage between the pump 5 and the pressure receiving chamber 8a through the porous orifice 15, and this state is referred to as a closed state of the solenoid valve 13 in the present embodiment.

On the other hand, in the state shown in FIG. 2, the solenoid valve 13 is brought into an opened state, the flow passage between the pump 5 and the pressure receiving chamber 8a is cut off by the solenoid valve 13, and the solenoid valve 13 communicates a flow passage between the pressure receiving chamber 8a and the tank 17 through the porous orifice 15 and the check valve 14.

The port switching of the servo switching valve 10 and the opening and closing of the solenoid valve 13 are controlled by the control unit 19.

In FIG. 1, the dump valve 8 is provided with a valve body 8b and a pressure receiving body 8c. The valve body 8b abuts against an opening edge of the hole portion 7a that forms a portion of the flow passage 7, thereby blocking the hole portion 7a. The pressure receiving body 8c is connected to the valve body 8b and disposed in the pressure receiving chamber 8a, and presses the valve body 8b toward the hole portion 7a (that is, a direction in which the flow passage 7 is cut off) by the pressure (emergency cutoff oil pressure) of the hydraulic oil supplied to the pressure receiving chamber 8a. Additionally, the dump valve 8 is provided with a spring (biasing body) 8d that biases the pressure receiving body 8c to the side opposite to the hole portion 7a, thereby biasing the valve body 8b to the side (that is, a direction in which the valve body 8b opens the hole portion 7a) opposite to the hole portion 7a. The valve bodies 8b and the pressure receiving body 8c have a disc shape, respectively, and the external diameter of the pressure receiving body 8c is larger than the external diameter of the valve body 8b.

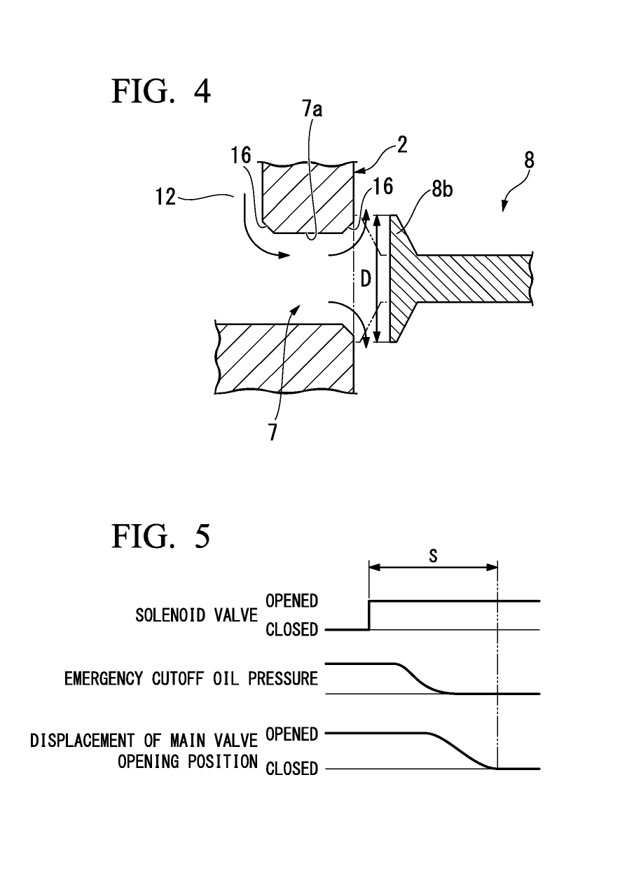

In FIG. 4, in the present embodiment, the diameter D (specifically, the diameter of a blocking face of the valve body 8b that abuts against the opening edge of the hole portion 7a) of the valve body 8b of the dump valve 8 is 3.5 inches. It is preferable that the diameter D of the valve body 8b be 3.0 to 5.0 inches.

Additionally, in FIG. 1, in the present embodiment, the ratio of the area (in the following, abbreviated as pressure receiving area A2) by which the valve body 8b receives pressure from the fluid (the fluid of the second chamber 12) of the hole portion 7a to the area (in the following, abbreviated as pressure receiving area A1) by which the pressure receiving body 8c receives pressure from the fluid of the pressure receiving chamber 8a is 0.78. It is preferable that the ratio of the pressure receiving area A2 to the pressure receiving area A1 be 0.7 to 0.8.

Specifically, in the present embodiment, the diameter of an inner wall of the hole portion 7a is 85 mm, and the diameter of an outer wall of the pressure receiving body 8c is 96 mm. The diameter of the inner wall of the hole portion 7a is the diameter of a region where the blocking face of the valve body 8b receives pressure from the fluid within the hole portion 7a.

The flow passage 7 branches between the dump valve 8 and the first chamber 11 and also communicates with the tank 17.

As shown in FIG. 4, an inner wall of the flow passage 7 is formed with a guide portion 16 that gradually changes the flowing direction of hydraulic oil stepwise or continuously. The guide portions 16 are arranged at a corner portion that protrudes toward the inside of the flow passage 7 in the inner wall of the flow passage 7, are formed by chamfering processing, curved surface (R) processing, or the like, and smoothly connect an upstream portion and a downstream portion of the corner portion in the inner wall of the flow passage 7.

In the present embodiment, the guide portion 16 is formed into a chamfered shape, and is formed at a corner portion where the flowing direction of hydraulic oil is changed 90° in the inner wall of the flow passage 7 in a vertical cross-sectional view shown in FIG. 4. The guide portion 16 extends in a direction that inclines at 45° with respect to an upstream inner wall portion of the corner portion and extends in a direction that inclines at 45° also with respect to a downstream inner wall portion of the corner portion. It is noted herein that the inclination angle of the guide portion 16 is not limited to 45° of the present embodiment.

In addition, the guide portion 16 may be formed into a convex curve shape, and may be formed so that the flowing direction of hydraulic oil is continuously and gradually changed from the upstream toward the downstream in the inner wall of the flow passage 7.

Additionally, the guide portion 16 is formed at least at the opening edge (the opening edge that abuts against the valve body 8b) of the hole portion 7a, and specifically, the guide portion 16 of the present embodiment is formed by chamfering processing of C0.5. It is preferable that the guide portion 16 be formed by chamfering processing of C0.4 to 0.6. In addition, in the illustrated example, the guide portion 16 is also formed at an inner wall corner portion of a region that opens toward the second chamber 12 side in the hole portion 7a.

Next, the valve opening operation and valve closing operation of the steam valve 4 by the actuator 1 of the present embodiment will be described.

[Valve Opening Operation]

In FIG. 1, high-pressure oil is supplied from the pump 5 to the servo switching valve 10, and emergency cutoff oil is supplied to the solenoid valve 13. As shown in FIG. 1, the high-pressure oil is supplied from the servo switching valve 10 through the hole portion 7a of the flow passage 7 to the second chamber 12 by bringing the solenoid valve 13 into a closed state. The emergency cutoff oil is supplied from the solenoid valve 13 through the porous orifice 15 to the pressure receiving chamber 8a of the dump valve 8. Thereby, since a force that presses the valve body 8b toward the hole portion 7a via the pressure receiving body 8c by the oil pressure of the emergency cutoff oil exceeds the sum of a force that the oil pressure of the high-pressure oil presses the valve body 8b toward the side opposite to the hole portion 7a, and the biasing force applied by the spring 8d, the hole portion 7a is blocked by the valve body 8b.

Here, the high-pressure oil pressure (the internal pressure of the hole portion 7a) and the emergency cutoff oil pressure (the internal pressure of the pressure receiving chamber 8a) are the same as each other. Additionally, since (the pressure receiving area A1)×(the emergency cutoff oil pressure) is larger than the sum of (the pressure receiving area A2)×(the high-pressure oil pressure) and the force with which the spring 8d biases the pressure receiving body 8c toward the side opposite to the hole portion 7a, the valve body 8b of the dump valve 8 is pressed against the hole portion 7a, and abuts the opening edge of the hole portion 7a.

In this way, as the high-pressure oil is supplied from the servo switching valve 10 to the second chamber 12 in a state where the dump valve 8 is closed, the internal pressure (high-pressure oil pressure) of the second chamber 12 is made higher than the internal pressure of the first chamber 11 and exceeds the biasing force applied by the elastic member 6, causing the piston 3 to move toward the first chamber 11 to open the steam valve 4.

[Valve Closing Operation]In FIG. 2, first, the solenoid valve 13 is brought into an opened state. Thereby, supply of the emergency cutoff oil is stopped, a portion of the emergency cutoff oil flows to the tank 17, and the oil pressure of the emergency cutoff oil drops.

As the emergency cutoff oil pressure drops, (the pressure receiving area A1)×(the emergency cutoff oil pressure) becomes less than or equal to (the pressure receiving area A2)×(the high-pressure oil pressure). The valve body 8b of the dump valve 8 is moved toward the pressure receiving body 8c opposite to the hole portion 7a by the biasing force applied by the spring 8d, and the hole portion 7a is opened whereby the flow passage 7 communicates with the second chamber 12.

If the flow passage 7 is opened, the internal pressure of the second chamber 12 and the internal pressure of the first chamber 11 become equal to each other, the piston 3 moves toward the second chamber 12 by the biasing force applied by the elastic member 6, and the steam valve 4 is opened. In this case, the high-pressure oil of the second chamber 12 flows out of the second chamber 12 and flows into the first chamber 11 through the flow passage 7. In addition, a portion of the high-pressure oil (excess oil or the like supplied from the servo switching valve 10) that flows through the flow passage 7 is discharged to the tank 17. Additionally, the port of the servo switching valve 10 is switched, and the supply of the high-pressure oil is stopped.

A time chart shown in FIG. 5 has the horizontal axis as time, the vertical axis in the solenoid valve indicates the opening position of the solenoid valve, the vertical axis in the emergency cutoff oil pressure indicates pressure, and the vertical axis in the main valve (steam valve 4) indicates the opening position of the main valve. In the time chart shown in FIG. 5, as the solenoid valve 13 is brought into an opened state, the emergency cutoff oil pressure within the pressure receiving chamber 8a drops, and the high-pressure oil of the second chamber 12 flows out of the second chamber 12 and flows into the first chamber 11 through the flow passage 7. The main valve (steam valve 4) is closed so as to follow the drop of the emergency cutoff oil pressure.

The time (main valve closing time) S until the main valve (steam valve 4) is closed after the solenoid valve 13 is brought into an opened state is, for example, about 0.15 to 0.2 seconds.

In addition, in the present embodiment, a plurality of the actuators 1 is provided so as to be connected in parallel with each other. Therefore, the aforementioned valve opening operation and valve closing operation are simultaneously performed in all the actuators 1.

In the actuator 1 of the present embodiment described above, the high-pressure oil is supplied from the servo switching valve 10 to the second chamber 12 so as to resist the biasing force applied by the elastic member 6. That is, in FIG. 1, in the actuator 1 of the present embodiment, the internal pressure of the second chamber 12 is made higher than the internal pressure of the first chamber 11, and is made to act on the piston 3 so as to push up the piston. The biasing force that biases the piston 3 toward the second chamber 12, and the internal pressure of the second chamber 12 are balanced, and the piston 3 is arranged at a predetermined position within the cylinder 2. This brings the steam valve 4 into an opened state.

From this state, the dump valve 8 opens the flow passage 7, which was cut off by the dump valve 8, to allow the first chamber 11 and the second chamber 12 to communicate with each other, in FIG. 2, the internal pressures of the first chamber 11 and the second chamber 12 become equal to each other, the piston 3 is moved to the second chamber 12 by the biasing force applied by the elastic member 6, and the steam valve 4 is quickly closed.

According to the actuator 1 of the present embodiment, only one dump valve 8 has to be provided in the flow passage 7 that allows the first chamber 11 and the second chamber 12 to communicate with each other, and the structure is simple. Additionally, since the amount (discharge amount) of the hydraulic oil discharged from the second chamber 12 and the amount (supply amount) of the hydraulic oil supplied to the first chamber 11 can be easily made equal to each other, the movement of the piston 3 can be rapidly and stably performed, and the steam valve 4 connected to the piston 3 can be rapidly and stably closed.

Additionally, since the inner wall of the flow passage 7 is formed with the guide portion 16, when the dump valve 8 is opened, the flowing direction of the hydraulic oil that is directed from the second chamber 12 to the first chamber 11 is smoothly changed stepwise or continuously by the guide portions 16 within the flow passage 7, the hydraulic oil is not easily separated (spaced apart) from the inner wall, that is, the hydraulic oil flows so as to run along the inner wall, and the pressure loss is reduced. Accordingly, the flow velocity of the hydraulic oil that flows through the flow passage 7 can be raised, and the aforementioned effects become more remarkable.

Additionally, since the guide portion 16 is formed at least at the opening edge of the hole portion 7a, when the valve body 8b is spaced apart from the opening edge of the hole portion 7a to open the hole portion 7a, the pressure loss of the hydraulic oil that flows between the opening edge and the valve body 8b is effectively suppressed, and the aforementioned effects are markedly obtained.

Moreover, since the guide portion 16 is formed by chamfering of C0.4 to 0.6, the aforementioned effects become more remarkable. That is, in a case where the guide portion 16 is formed by chamfering smaller than chamfering of C0.4, there is a concern that the aforementioned effect of suppressing pressure loss may not be sufficiently obtained. Additionally, in a case where the guide portion 16 is formed by chamfering larger than chamfering of C0.6, there is a concern that securement of the sealing performance of the seat of the valve body 8b with respect to the opening edge of the hole portion 7a may become difficult. Accordingly, it is preferable that the chamfering processing of the guide portion 16 be C0.4 to 0.6. Additionally, in a case where the guide portion 16 is formed by chamfering of C0.5 as in the present embodiment, this is more preferable because the effect of suppressing pressure loss is obtained to a maximum extent while the sealing performance of the seat of the valve body 8b with respect to the opening edge of the hole portion 7a is sufficiently secured.

Additionally, the diameter D of the valve body 8b is 3.0 to 5.0 inches, and a large internal diameter of the hole portion 7a blocked by the valve body 8b can be secured. This allows the flow rate of hydraulic oil per unit time that passes through the hole portion 7a to be increased. Accordingly, the steam valve 4 can be more quickly opened and closed.

That is, if the diameter D of the valve body 8b is made smaller than 3.0 inches, there is a concern that the flow rate of hydraulic oil cannot be increased. Additionally, if the diameter D of the valve body 8b is made larger than 5.0 inches, it is not preferable because the outer shape of the dump valve 8 also becomes larger correspondingly and the interference is likely to occur in various piping or the like in plants. Accordingly, it is preferable that the diameter D of the valve body 8b be 3.0 to 5.0 inches. In addition, in a case where the diameter D of the valve body 8b is 3.5 inches as in the present embodiment, this is desirable because the flow rate of hydraulic oil can be sufficiently increased while the interference with various piping or the like is prevented.

Additionally, since the ratio of the pressure receiving area A2 of the valve body 8b to the pressure receiving area A1 of the pressure receiving body 8c is 0.7 to 0.8, the following effects are exhibited.

That is, in the dump valve 8, the dump valve 8 is opened when (the pressure receiving area A2 of the valve body 8b)×(the high-pressure oil pressure) exceeds (the pressure receiving area A1 of the pressure receiving body 8c)×(the emergency cutoff oil pressure). Specifically, in the example described in the present embodiment, the dump valve 8 is opened when the sum of (the pressure receiving area A2 of the valve body 8b)×(the high-pressure oil pressure) and (the biasing force applied by the spring 8d) exceeds (the pressure receiving area A1 of the pressure receiving body 8c)×(the emergency cutoff oil pressure). In addition, the spring 8d may not be provided. However, it is preferable that the spring 8d is provided as in the present embodiment, so that the dump valve 8 can be quickly opened.

According to the present embodiment, since (the pressure receiving area A2)/(the pressure receiving area A1) is raised to 0.7 to 0.8, the dump valve 8 can be more quickly operated when the emergency cutoff oil pressure drops. Here, since the emergency cutoff oil pressure drops gently due to the pressure loss or the like of the piping line, the effects by the configuration of the present embodiment are more easily obtained.

In addition, if (the pressure receiving area A2)/(the pressure receiving area A1) becomes smaller than 0.7, there is a concern that the effect of rapidly operating the dump valve 8 may not be sufficiently obtained. Additionally, if (the pressure receiving area A2)/(the pressure receiving area A1) becomes larger than 0.8, there is a concern that the securement of the sealing performance of the seat of the valve body 8b with respect to the opening edge of the hole portion 7a may become difficult. Accordingly, it is preferable that (the pressure receiving area A2)/(the pressure receiving area A1) be 0.7 to 0.8. In addition, in a case where (the pressure receiving area A2)/(the pressure receiving area A1) is set to 0.78 as in the present embodiment, this is more preferable because the effect of rapidly operating the dump valve 8 is obtained to a maximum extent while the sealing performance of the seat of the valve body 8b with respect to the opening edge of the hole portion 7a is sufficiently secured.

Additionally, one branch line provided with the check valve 14, and the other branch line provided with the porous orifice 15 are provided in the piping line that connects the solenoid valve 13 and the pressure receiving chamber 8a. When the solenoid valve 13 is opened, the emergency cutoff oil flows from the pressure receiving chamber 8a toward the tank 17 through the both branch lines. This reduces the pressure loss of the emergency cutoff oil and further shortens the valve closing time of the steam valve 4.

Additionally, in the actuator 1 of the present embodiment, the dump valve 8 is integrally incorporated into the cylinder 2. Specifically, a piping member is not provided between the second chamber 12 of the cylinder 2 and the dump valve 8, and the second chamber 12 of the cylinder 2 is directly connected with the dump valve 8 through the hole portion 7a that is a fluid port formed in the casing 8e of the dump valve 8. By virtue of such a configuration, the actuator 1 of the present embodiment can reduce the number of parts. Additionally, since the actuator 1 itself can be made small, the actuator can be installed even in a narrow space. Moreover, since the second chamber 12 of the cylinder 2 is directly connected with the dump valve 8 through the fluid port (hole portion 7a), the length of the fluid port can be shortened. By shortening the length of the fluid port, the response of the steam valve 4 improves because a large amount of hydraulic oil for control can be rapidly made to flow from the second chamber 12 of the cylinder 2 to the tank through the fluid port. Additionally, the pressure loss of the hydraulic oil for control that passes through the fluid port decreases.

In addition, the present invention is not limited to the aforementioned embodiment, and various changes can be made without departing from the scope of the present invention.

For example, the steam valve 4 is quickly closed by the actuator of the aforementioned embodiment from a state where the flow of steam is allowed, and cuts off the flow of steam. However, the present invention is not limited to this. Conversely, the steam valve 4 may be quickly opened from a state where the flow of steam is cut off to allow the flow of steam.

Additionally, in the actuator of the aforementioned embodiment, description has been made using the steam valve 4 that cuts off or communicates the flow of steam. However, fluids other than the steam may be used, and a main valve that communicates or cuts off the fluid may be used.

In addition, the constituent elements described in the aforementioned embodiment and modifications (the above additional remarks or the like) of the present invention may be appropriately combined. Additionally the aforementioned constituent elements can be substituted with well-known constituent elements without departing from the scope of the present invention.

### INDUSTRIAL APPLICABILITY

According to the actuator of the present invention, the main valve can be quickly and stably opened and closed while making the structure simple.

### REFERENCE SIGNS LIST

1: Actuator
2: Cylinder
3: Piston
4: Steam Valve (Main Valve)
6: Elastic Member (Biasing Device)
7: Flow Passage
7a: Hole Portion
8: Dump Valve (Pilot Valve)
8a: Pressure Receiving Chamber
8b: Valve Body
8c: Pressure Receiving Body
10: Servo Switching Valve (Fluid Supplying Device)
11: First Chamber
12: Second Chamber
16: Guide Portion
21: Wall Surface Portion
71: Piping Member
A1: Pressure Receiving Area (Area by Which Pressure Receiving Body Receives Pressure from Fluid of Pressure Receiving Chamber)
A2: Pressure Receiving Area (Area by Which Valve Body Receives Pressure from Fluid of the Hole Portion)
D: Diameter of Valve Body

1. An actuator comprising:
a cylinder that has a tubular shape and is filled with a fluid;
a piston that divides the inside of the cylinder into a first chamber and a second chamber in an axial direction of the cylinder, is reciprocable inside the cylinder, and opens and closes a main valve;
a fluid supplying device for supplying the fluid to the second chamber;
a biasing device for biasing the piston in the axial direction toward the second chamber;
a flow passage that communicates between the first chamber and the second chamber; and
a pilot valve that cuts off the flow passage communicating between the first chamber and the second chamber.

2. The actuator according to claim 1,
wherein an inner wall of the flow passage is formed with a guide portion that gradually changes the flowing direction of the fluid stepwise or continuously.

3. The actuator according to claim 2,
wherein the pilot valve includes a valve body that abuts an opening edge of a hole portion that forms a portion of the flow passage, thereby blocking the opened hole portion, and
wherein the guide portion is formed at least at the opening edge of the hole portion.

4. The actuator according to claim 3,
wherein the guide portion is formed by chamfering processing of C0.4 to 0.6.

5. The actuator according to claim 1,
wherein the pilot valve includes a valve body that abuts an opening edge of a hole portion that forms a portion of the flow passage, thereby blocking the opened hole portion, and
wherein the diameter of the valve body is 3.0 to 5.0 inches.

6. The actuator according to claim 1,
wherein the fluid is supplied to a pressure receiving chamber of the pilot valve so that a pressure of the pressure receiving chamber becomes equal to that of the second chamber,
wherein the pilot valve includes:
a valve body that abuts an opening edge of a hole portion that forms a portion of the flow passage, thereby blocking the opened hole portion; and
a pressure receiving body that is connected to the valve body, is disposed inside the pressure receiving chamber, and presses the valve body toward the hole portion by the pressure of the fluid supplied to the pressure receiving chamber, and
wherein the ratio of the area by which the valve body receives pressure from the fluid of the hole portion to the area by which the pressure receiving body receives pressure from the fluid of the pressure receiving chamber is 0.7 to 0.8.
